(19) United States
(12) Patent Application Publication
(10) Pub. No.: US 2004/0181501 A1
(43) Pub. Date: Sep. 16, 2004

(54) Parallelizable system for concise representation of data

(75) Inventors: Douglas R. Burdick, Ithaca, NY (US); Steven Rostedt, Endwell, NY (US); Robert J. Szczerba, Endicott, NY (US)

Correspondence Address: TAROLLI, SUNDHEIM, COVELL & TUMMINO LLP, 1111 LEADER BLDG., CLEVELAND, OH, 44114, US

(73) Assignee: Lockheed Martin Corporation

(21) Appl. No.: 10/385,536

(22) Filed: Mar. 11, 2003

(51) Int. Cl. G06F 7/00

(52) U.S. Cl. 707/1

(57) ABSTRACT

A system represents data during a data cleansing application. The system includes a record collection. Each record in the collection includes a list of fields and data contained in each field. The system further includes a predetermined sequence of operations to be performed on the record collection and a plurality of bit-maps representing the record collection. The system still further includes a partitioned sequence of operations for parallel processing of the bit-maps by a plurality of separate devices.

### FIELD OF THE INVENTION

The present invention relates to a system for representation of data and, more particularly, to a parallelizable system for concise representation of record sets.

### BACKGROUND OF THE INVENTION

In today's information age, data is the lifeblood of any company, large or small, federal or commercial. Data is gathered from a variety of different sources in a number of different formats or conventions. Examples of a data sources may be: customer mailing lists, call-center records, sales databases, etc.

Each record may contain different pieces of information (possibly in different formats) about the same type of entities (customers in this case). A record may contain information about a real-world entity. Each record may be divided into fields, where each field describes an attribute of the entity. Data from these sources may either be stored separately or integrated together to form a single repository (i.e., a data warehouse, a data mart, etc.). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this situation. The quality of the analysis performed by these tools suffers dramatically if the data analyzed contains redundancies, incorrect values, or inconsistent values. This “dirty” data may be the result of a number of different factors including, but certainly not limited to, the following: spelling errors (phonetic and typographical), missing data, formatting problems (wrong field), inconsistent field values (both sensible and non-sensible), out of range values, synonyms, or abbreviations. Because of these errors, multiple database records may inadvertently be created in a single data source relating to the same object or records may be created which don't seem to relate to any object.

A “data cleansing” application may solve the problem of finding these duplicate record sets, or sets of records describing the same real-world entity. Over the course of execution, the cleansing application may maintain information about groups of records that may be potential duplicates. Records may be grouped together for further processing by a data cleansing application because these records share an “interestingly similarity characteristic.” The interestingly similarity characteristic may describe why the cleansing application thinks the records in the set potentially refer to the same real-world entity. Examples of interestingly similarity characteristics may be records having the same value for 1 or more fields, records coming from a particular source, records coming from a particular source having the same value for 1 or more fields, etc.

Further processing may include the combination of these “interesting” sets of records together using set operations such as INTERSECTION, UNION, an/or DIFFERENCE. In practice, there may be a large number of “interesting” sets created during execution of various data cleansing steps, and a large number of operations performed involving these interesting sets. Thus, a cleansing application may require a representation of interesting record sets that has the following characteristics: 1) utilization of a small amount of space to represent the record set (as small as possible); 2) efficient implementation of set operations used to further process these interesting sets (i.e., INTERSECTION, UNION, DIFFERENCE, etc.); 3) allowance of additional information to be stored with the interesting record set (as needed by the cleansing application); and/or 4) full utilization of parallel computing architectures.

All four of these characteristics may be represented for record sets of different sizes. For example, in large record collections, some interesting record sets may contain many records while other sets may contain few records. Conventionally, bitmaps have been utilized to represent these four characteristics.

One of the weaknesses with simple bitmaps is that a great deal of space may be wasted, because every record in the collection must be represented by a single bit. If the number of records in a set is much smaller relative to the total size of a record collection, small representations of the record set, other than the simple bitmap, may be desirable.

A conventional method may be based on the observation that there can be long sequences of bits set to 0 between the bits set to 1. For example, FIGS. 1 and 10(a) show a string of 35 “0”s between bits 12 and 48. Instead of representing all of the 0 values between two 1-bits, the number of zeros between each 1 value may be represented in a size reduced manner.

This type of representation is known as run-length encoding. An example of what run-length encoding would look like for the example record set (FIGS. 1 & 10(a)) of records 3, 9, 12, 48 is shown in FIG. 10(b). Instead of using bitmaps, simply listing the identifier for records (as an integer) in the set is also possible. In the case of 50 records in the record collection, the set consisting of records 3, 9, 12, and 48 may be represented. The integers 3, 9, 12, and 48 would be placed into a list, as shown in FIG. 10(c) While alternative representations may potentially save space over the simple bitmap representation, an efficient way to perform all of the set operations (i.e., intersection, union, difference, etc.) on these compressed set representations is not contemplated by the conventional method. Usually, decompression/compression operations are involved in processing these representations, which becomes a significant resource expenditure if done repeatedly.

Furthermore, conventional data structures that address this problem are not designed to take full advantage of parallelization (or parallel computing architectures) that may be available. Thus, conventionally, there is no efficient way to partition the data structure itself or larger data structures created by aggregating a collection of the smaller structures together. This inherently limits the data structure to a single machine.

### SUMMARY OF THE INVENTION

A system in accordance with the present invention represents data during a data cleansing application. The system includes a record collection. Each record in the collection includes a list of fields and data contained in each field. The system further includes a predetermined sequence of operations to be performed on the record collection and a plurality of bit-maps representing the record collection. The system still further includes a partitioned sequence of operations for parallel processing of the bit-maps by a plurality of separate devices.

A method in accordance with the present invention represents data during a data cleansing application. The method includes the steps of: providing a record collection, each record in the collection including a list of fields and data contained in each field; providing a predetermined sequence of operations to be performed on the record collection; creating a plurality of bit-maps for representing the record collection; partitioning the predetermined sequence of operations for parallel processing of the bit-maps by a plurality of separate devices.

A computer program product in accordance with the present invention cleanses data. The product includes an input record collection. Each record in the collection includes a list of fields and data contained in each field. The program further includes an input predetermined sequence of operations to be performed on the record collection and a plurality of bit-maps created by the program. The bit-maps represent the record collection. The program still further includes a partitioned sequence of operations for parallel processing of the bit-maps by a plurality of separate devices. The sequence is partitioned by the program.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of example data for use with the present invention;

FIG. 2 is a schematic representation of more example data for use with the present invention;

FIG. 3 is a schematic representation of still more example data for use with the present invention;

FIG. 4 is a schematic representation of example data utilized by the present invention;

FIG. 5 is a schematic representation of more example data utilized by the present invention;

FIG. 6 is a schematic representation of still more example data utilized by the present invention;

FIG. 7 is a schematic representation of a system in accordance with the present invention;

FIG. 8 is a schematic representation of yet more example data utilized by the present invention;

FIG. 9 is a schematic representation of still more example data utilized by the present invention; and

FIG. 10 is a schematic representation of yet more example data utilized by the present invention.

### DETAILED DESCRIPTION OF AN EXAMPLE EMBODIMENT

A system in accordance with the present invention introduces a novel bitmap-based data structure for representation of record sets of a record collection. The data structure allows efficient implementation of the following basic operations: insertion, deletion, and/or lookup of records in the structure. These basic operations may be utilized to perform set operations needed to combine these record sets during execution of a data cleansing application.

The system further provides a mechanism for storing additional information along with the record set for annotation of the record set. This additional information may be used to enhance a cleansing application and may comprise any information the data cleansing application requires.

Additionally, the system may include an optimizing process to execute, as efficiently as possible, a listing of set operations over a record collection. This may include the efficient partitioning of information to several separate devices to best exploit parallel computing architectures.

The system may utilize a bitmap-based structure for representing the record set, known as a SPARSEBITS structure. As described above, a bitmap is an ordered sequence of bits and contains a bit for every record in the record collection. (i.e., bit 1 corresponds to record 1, bit 2 corresponds to record 2, etc.). If the record is in the set, the bit for the record may be set to 1. Otherwise, it may be set to 0. For example, in FIG. 1, an example record collection has 50 records. A bitmap representing the example record set 3, 9, 12 and 48 contains 50 bits (one bit for each record in the collection). Bits 3, 9, 12 and 48 would be set to 1. All of the other bits would be set to 0.

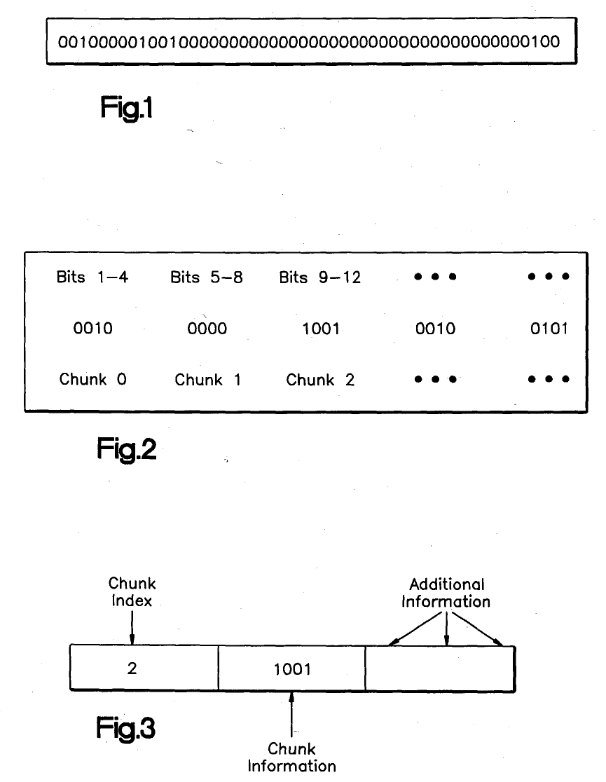

A bitmap may also be a sequence of equal sized pieces, or a series of bit “chunks”. For example, as viewed in FIG. 2, this sequence may be the number of bits in each chunk and be implementation specific, but relatively small. In FIG. 2, every four bits in the example sequence are represented by one logical “chunk.” Thus, bits 1-4 are in chunk 1, bits 5-8 in chunk 2, etc. To completely represent a record set, the position of bits with the value 1 in the bitmap need only be represented. With the bitmaps being represented as “chunks” of bits, only information about the “chunks” containing a bit set to 1 may be necessary to completely represent the record set.

FIG. 1 shows an example bitmap for the set containing records 3, 9, 12, 48. The SparseBits structure may store a representation of a record set by storing only the “chunks” of the bitmap that have a bit set to 1. Information about chunks is stored as “chunk objects”. The chunk objects are stored in a balanced binary tree to allow efficient access for further processing of the bitmap by a cleansing application.

A chunk object is illustrated in FIG. 3. The chunk object contains: a “chunk index” based on the order of the chunk in the sequence for the bitmap; the values for the bits in the chunk (i.e., the value for bits in the portion of the bitmap if the bitmap is broken into chunks, etc.); and additional information (i.e., specific to each cleansing application—for enhancement of further processing of the bitmap.

The SparseBits structure uses a balanced binary tree structure to store the chunk objects. An example of a balanced binary tree may be a Red-Black tree. The “chunks” are stored in the tree based on the value of the chunk index. Using a balanced binary tree allows very efficient access to any chunk, while providing all the advantages of storing the chunks in sorted order based on chunk index. The tree structure supports a wide range of basic operations (i.e., insertion, deletion, lookup, etc.) quite efficiently.

Since the chunks are of known size and ordered, a bit position corresponds to (chunk index * chunk size)+(offset into chunk). Since only information about which records are present in the set is necessary, chunk objects with at least a single bit set to 1 may only be stored.

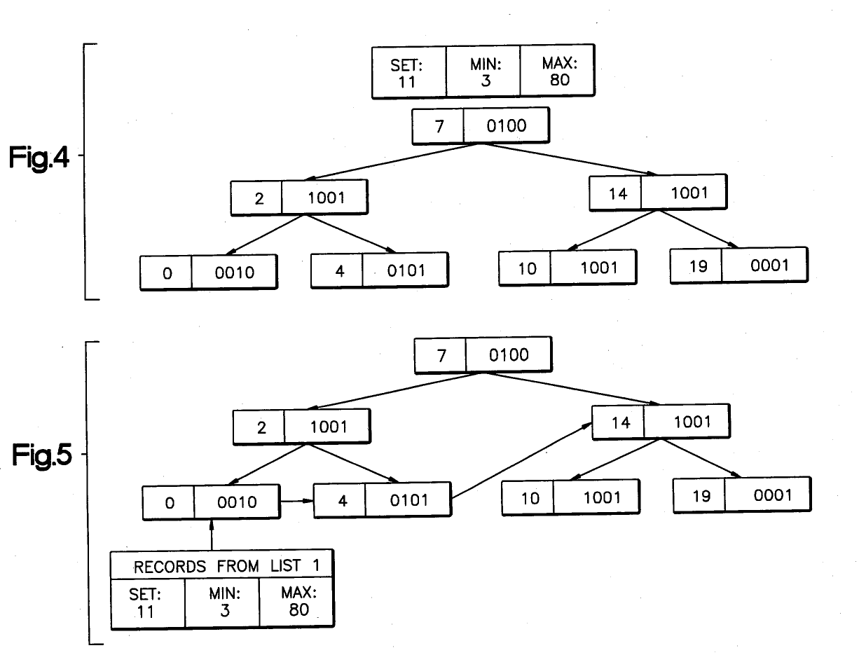

FIG. 4 illustrates an example SparseBits structure for the set of records 3, 9, 12, 18, 20, 30, 41, 44, 56, 60, 80. The chunk size is 4. Each chunk object stores information about 4 bits. The arrows represent the links between chunk objects in the tree. No chunk represents information for all zero bits. The left-most bit in a chunk has offset 1 and the right-most an offset of 4. Bit 3 would be in chunk 0 at offset 3. Additionally, each SparseBits stores the smallest and largest positions of 1-bits it represents (i.e., the minimum and maximum positions, etc.). This is shown in the MIN and MAX boxes in FIG. 4. In addition, each SparseBit structure stores the number of bits in it, which is stored in the SET box in FIG. 4.

A cleansing application may store additional information with the record set during cleansing application execution. This information may “annotate” the record set and enhance processing. A data cleansing application may process large collections of records. There may be a significant number of records sharing the “interesting similarity characteristic” and records may be linked together in the sets that share a more specialized interesting characteristic.

A record collection may also originate from multiple sources. Information about which record came from which source may be stored. Particular error sources may be detected and corrected with this information.

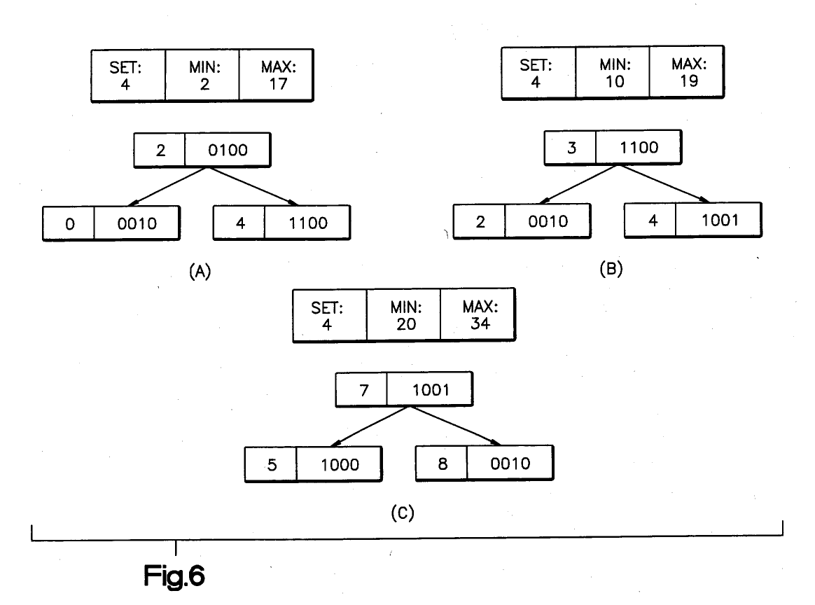

The same SparseBits structure for the record set 3, 9, 12, 18, 20, 30, 41, 44, 56, 60 and 80 of FIG. 4 is shown in FIG. 5. However, if the record collection originated from multiple sources, the data cleansing application may track records that originate from an example list 1. Records 3, 18, 20, 56 and 60 originated from list 1. All of the chunks that represent the presence of a record from list 1 together may be linked. The arrows added in FIG. 5 between the chunks represent this linkage.

For example, in FIG. 5, the records from list 1 are linked together in order. However, different configurations are possible for different applications. The record chunks containing records 3, 18, 20, 56 and 60 could all point back to list 1.

The MIN and MAX values may optimize set operations (or Boolean operations) involving several SparseBit structures. The system may exploit observations about these minimum and maximum position values to “short-circuit” operations for which the results can be inferred by only considering these values. The system may only process parts of the SparseBits structures to compute the final answer.

A group of sets represented in a collection of SparseBit structures may intersect (i.e., elements present in all of the sets represented, etc.). The system may only consider data between the highest minimum value and the lowest minimum value. Quickly accessing this information in the SparseBits structure is trivial, since the chunk data is stored in a balanced tree. Further, if the lowest maximum is greater than the highest minimum, then the result is guaranteed to have no 1-bit sets, since there cannot exist a position value shared by all sets.

In FIG. 6, the chunk size is 4 for each SparseBits structure. The three Sparsebit structures, labeled (a), (b), and (c), respectively, represent three sets to be intersected. Since the lowest maximum is greater than the highest minimum (i.e., SparseBits (c) has a min of 19, which is greater than 17—the max of SparseBits (a)), it is not possible for any position to be ON in all three SparseBits. Thus, the intersection of these sets is the empty set, or a Sparsebit structure with no bits set to 1.

A collection of SparseBit structures may be used to construct a larger data structure for processing by a higher-level application. For example, a collection of SparseBit structures may be used to represent the record sets tracked by a data cleansing application. Along with the SparseBit structures representing the sets being tracked, the data cleansing application may have a list of set operations to be performed on the Sparsebit structures for the application to execute. These two items may be given as input to an optimization process that rearranges the list of set operations (and possibly replaces set operations with more efficient, equivalent operations). This rearrangement of execution order and operation replacement does not impact the calculated result (i.e., the computed result is still the same as if the operations had been executed in the original order, etc.). However, it may significantly reduce intermediate computation and take fuller advantage of parallel computing architectures (if available).

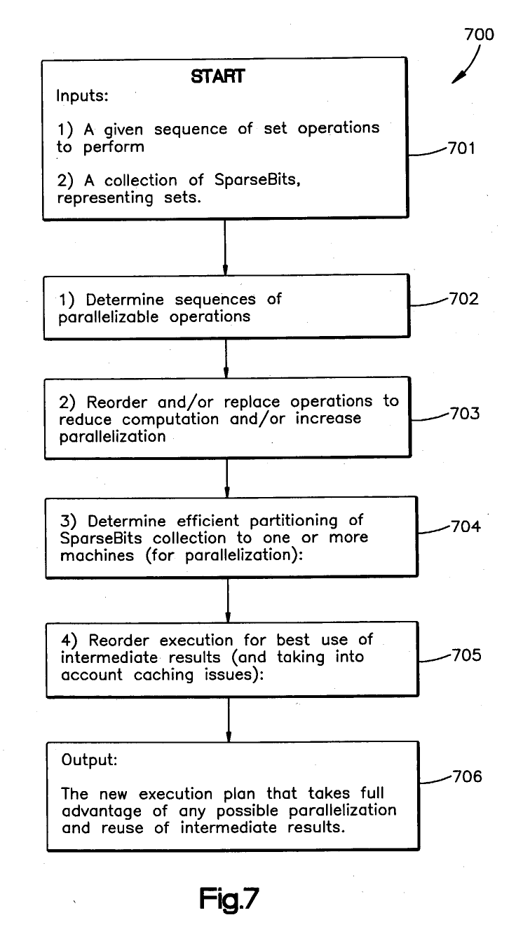

A high level overview of an example system 700 in accordance with the present invention is shown in FIG. 7. In step 701, the system 700 inputs an input sequence of set operations and a collection of SparseBit structures, representing sets. Following step 701, the system 700 proceeds to step 702. In step 702, the system 700 determines sequences of parallelizable operations. A sequence of parallelizable operations is a sequence of operations such that the result of the operations is the same regardless of the order in which the operations are executed. In other words, the operations do not interfere with each other. For operations updating the data structure (“writes”), each operation in the parallelizable sequence must involve a mutually exclusive subset of the data structure. For operations that simply query the data structure without modification (“reads”), there is no constraint. Depending on the higher-level applications, there likely will be many parallelizable sequences.

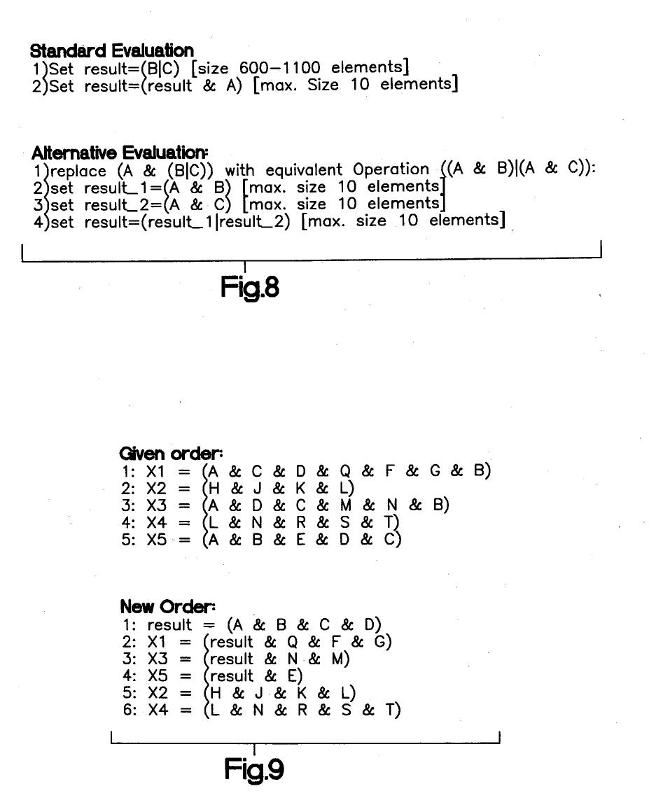

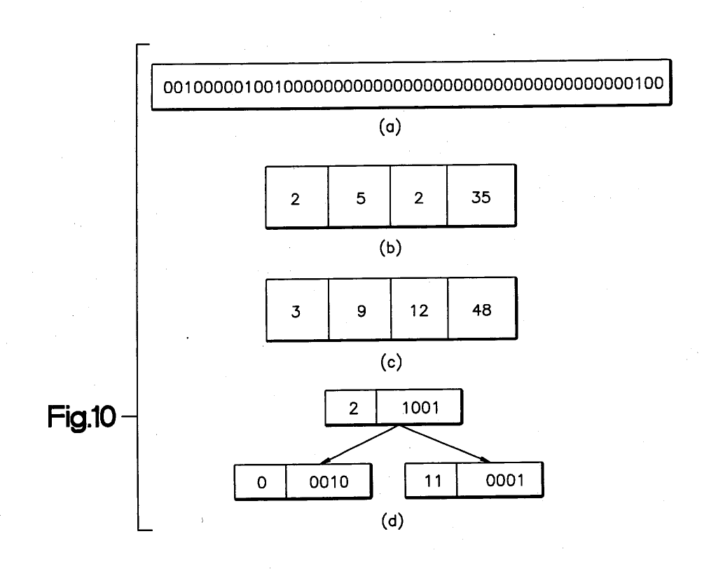

Following step 702, the system 700 proceeds to step 703. In step 703, the system 700 reorders and/or replaces operations to reduce computation and/or increase parallelization. It may be possible to reorder the list of operations to reduce the amount of computation needed to compute the intermediate results. For example, assume the system 700 is given 3 SparseBit structures, A, B and C, and must perform the following operation on them (A&(B|C). This operation instructs the system 700 to take the UNION of B and C and INTERSECT the result with A. Assume A has 10 elements, B has 500 elements, and C has 600 elements. The number of elements in (B|C) is between 600-1100 elements. The maximum number of elements in (A&(B|C)) is 10 elements. Instead of evaluating the operation in that order, the system 700 may recognize that the operation (A&(B|C) is equivalent to the operation ((A&C)|(A&B)). The latter operation has the advantage of limiting the size of the intermediate results, as illustrated in FIG. 8. In addition, the latter form is easier to parallelize, since (A & B) and (A & C) may be computed in parallel.

The concepts behind this example may be applied to more complex operations and/or more complex sequences of operations. Since each SparseBit structure stores the number of bits in it (i.e., the number of records in the set it represents, etc.), it is trivial to estimate reasonable bounds for the expected size of computed intermediate results.

For example, two SparseBit structures A and B may have a size equal to the number of 1's set in each SparseBit structure. For INTERSECT operations (or “&” operator), the size is the MIN(size(A), size (B)) of the operands. For UNION, the size is the range from MAX(size(A), size (B) to size(A)+size(B)). The optimization process will have a bias towards performing INTERSECTION operations as early as possible in the computation sequence, since this minimizes the size of intermediate results.

Following step 703, the system 700 proceeds to step 704. In step 704, the system 700 determines efficient partitioning of the SparseBit structure to one or more devices for parallelization. If a parallel computing architecture is available, there may be several possible ways to partition the SparseBit structures to a set of devices in a parallel architecture The system 700 may partition the SparseBit structures from the collection in such a way that potential for “short-circuiting” operations is maximized. An example of partitioning the SparseBit structures for INTERSECT and UNION operations is given below.

For optimizing INTERSECT operations, partition SparseBit structures from the collection to each device so that the Sparsebit structures “overlap” as little as possible (preferably have no overlap). “Overlap” means that two Sparsebit structures share the same range. For example, the SparseBit structures in FIG. 6(a) and FIG. 6(b) overlap, since they both share the range 10-19 (i.e., have the potential to have bits in the same range, etc.). The SparseBit structures in FIG. 6(a) and FIG. 6(c) do not overlap. Partitioning the SparseBit structures in this manner maximizes the potential for “short-circuiting” INTERSECTION operations. Any intersection of SparseBit structures on the same device may have most of the answer pre-computed from the partitioning process. The partitioning will be performed based on which SparseBit structures need to be intersected.

For optimizing UNION operations, partition portions of the SparseBit structures to each device, such that overlapping ranges of SparseBit structures are disposed the same device. This allows for the distributed processing of UNIONs. It may not be possible to “short-circuit” UNION operations, thus this is the optimum result that may be achieved.

Following step 704, the system 700 proceeds to step 705. In step 705, the system 700 reorders execution for optimal use of intermediate results (and taking into account caching issues). Depending on the nature of the computation, there may be several opportunities to re-use portions of prior computations.

In FIG. 8, the letters refer to a SparseBit structure from the collection. The list of operations has been determined to be parallelizable. Thus, the order of these operations may be changed without altering the results. The system 700 computes the first, third and fifth operations as intermediate results (1 & 2 & 3 & 4). Instead of computing this result multiple times, the system 700 may compute it just once, and reuse the result.

Additionally, reordering the operations for sequential execution, so that all operations utilize the result, maximizes the use of intermediate results already in the cache. While this is a very simple example of reusing intermediate results, these concepts may be applied to more complex situations.

Following step 705, the system 700 proceeds to step 706. In step 706, the system 700 outputs a strategy for evaluating the set of operations over the input collection of SparseBit structures.

A system in accordance with the present invention, called SparseBits above, is an improved bitmap-based data structure representing sets of records from a larger record collection. The SparseBits structure uses a small amount of space for set representation while also efficiently supporting the set operations (i.e., INTERSECTION, UNION, DIFFERENCE, etc.) used for combining record sets together during execution of a data cleansing application. The structure also has the capacity to store additional information along with the record set (for purposes of annotating records in the set).

Additionally, the example system 700 may include an optimizing process to execute, as efficiently as possible, a listing of set operations over an input collection of SparseBit structures. This includes a method for efficiently partitioning information to several devices to optimally exploit parallel computing architectures.

A system having the SparseBits data structure may provide improvement in three basic areas: utilization of a small amount of space for set representation; efficient set manipulation; and storage of additional information with the record set to enhance processing by a cleansing application.

Conventional uncompressed bitmaps are too large because a bit must be present for every record in the collection, even if there are very few records in the actual set. The simple bitmap represents information about both the presence and absence of a record from the set when only information about which records are present in the set is needed. This creates an issue for large record collections (millions of records) encountered in typical industrial data cleansing applications, since each bitmap has a size in megabits (millions of bits). This becomes problematic when large numbers of such sets must be stored. The example system 700 in accordance with the present invention improves this area of concern.

Additionally, operations for set manipulation are typically linear in the number of bits present in the bitmap, thereby overly taxing the most efficient representation of these operations. Although smaller, conventional alternative compressed representation (using techniques similar to those described above) does not efficiently support the logical set operations needed for further processing by the cleansing application. Additionally, there is the cost of compression/decompression operations.

Further, none of the conventional representations allow the storage of additional information with the record set in any form. The example system 700 allows additional information to be stored with the record set, for purposes of annotating the record set. This additional information helps to enhance processing of the record set by the cleansing application.

The example system 700 also includes a method for taking full advantage of parallel computing architectures. The example system 700 further includes an optimization process to execute a sequence of set operations over an input collection of SparseBits structures, as efficiently as possible. The example system 700 rearranges the sequence of operations to fully exploit a possible “short-circuiting” set of operations and best use intermediate results.

In accordance with another example feature of the present invention, a computer program product cleanses data. The product includes an input record collection. Each record in the collection includes a list of fields and data contained in each field. The program further includes an input predetermined sequence of operations to be performed on the record collection and a plurality of bit-maps created by the program. The bit-maps represent the record collection. The program still further includes a partitioned sequence of operations for parallel processing of the bit-maps by a plurality of separate devices. The sequence is partitioned by the program.

From the above description of the invention, those skilled in the art will perceive improvements, changes and modifications. Such improvements, changes and modifications within the skill of the art are intended to be covered by the appended claims.

Having described the invention, the following is claimed:

1. A system for representing data during a data cleansing application, said system comprising:
a record collection, each record in said collection including a list of fields and data contained in each said field;
a predetermined sequence of operations to be performed on said record collection;
a plurality of bit-maps representing said record collection;
a partitioned sequence of operations for parallel processing of said bit-maps by a plurality of separate devices.

2. The system as set forth in claim 1 further including a reordered sequence of operations optimizing the use of intermediate outputs of said operations.

3. The system as set forth in claim 2 further including stored information regarding the source of each record in said collection.

4. The system as set forth in claim 3 wherein said reordered sequence has been short-circuited to eliminate unnecessary operations.

5. The system as set forth in claim 4 wherein said reordered sequence processes intersection operations prior to union operations.

6. A method for representing data during a data cleansing application, said method comprising the steps of:
providing a record collection, each record in the collection including a list of fields and data contained in each field;
providing a predetermined sequence of operations to be performed on the record collection;
creating a plurality of bit-maps for representing the record collection;
partitioning the predetermined sequence of operations for parallel processing of the bit-maps by a plurality of separate devices.

7. The method as set forth in claim 6 further including the step of reordering the sequence of operations for optimizing the use of intermediate outputs of the operations.

8. The method as set forth in claim 7 further including the step of storing information regarding the source of each record in the collection.

9. The method as set forth in claim 8 further including the step of short-circuiting the reordered sequence to eliminate unnecessary operations.

10. The method as set forth in claim 9 further including the step of processing intersection operations prior to union operations.

11. A computer program product for cleansing data, said product comprising:
an input record collection, each record in said collection including a list of fields and data contained in each said field;
an input predetermined sequence of operations to be performed on said record collection;
a plurality of bit-maps created by said program, said bit-maps representing said record collection;
a partitioned sequence of operations for parallel processing of said bit-maps by a plurality of separate devices, said sequence partitioned by said program.

12. The program as set forth in claim 11 further including a sequence of operations optimizing the use of intermediate outputs of said operations, said sequence being reordered by said program.

13. The system as set forth in claim 12 further including stored information regarding the source of each record in said collection.

14. The system as set forth in claim 13 wherein said reordered sequence has been short-circuited to eliminate unnecessary operations.

15. The system as set forth in claim 14 wherein said reordered sequence processes intersection operations prior to union operations.
